(19) United States
(12) Patent Application Publication
(10) Pub. No.: US 2026/0260374 A1
(43) Pub. Date: Sep. 3, 2026

(54) METHOD OF, ARRANGEMENT FOR AND DATA PROCESSING PROGRAM PRODUCT FOR DETERMINING THE ORIENTATION OF AN EXTERIOR REAR VIEW ASSEMBLY FOR ROAD VEHICLES

(71) Applicant: MOTHERSON INNOVATIONS COMPANY LIMITED, London (GB)

(72) Inventors: Su-Birm PARK, London (GB); Matthias KOLLER, London (GB)

(21) Appl. No.: 19/163,539

(22) PCT Filed: Feb. 21, 2024
(86) PCT No.: PCT/EP2024/054338

§ 371 Date: Sep. 9, 2025

(30) Foreign Application Priority Data
Mar. 9, 2023 (DE) 10 2023 105 911.4

(51) Int. Cl. G06T 7/73; B60R 1/062; G06T 7/13

(52) U.S. Cl. CPC G06T 7/73; B60R 1/062; G06T 7/13; G06T 2207/30168; G06T 2207/30244; G06T 2207/30252

(57) ABSTRACT

A method, arrangement and data processing program product is provided for determining the orientation of an exterior rear view assembly with respect to a reference body, in particular a vehicle body, wherein:
image data of an image sensor mounted to the exterior rear view assembly or to the reference body is analyzed with respect to technical image data comprising technical image parameter data and/or focusing data and/or non-focusing data; and
an indication for the orientation of the exterior rear view assembly with respect to the reference body and/or an indication for a deviation of the orientation of the exterior rear view assembly with respect to the reference body is derived from the technical image data and/or from deviations of the technical image data.

### FIELD OF THE INVENTION

The present invention relates to a method of, an arrangement for and a data processing program product for determining the orientation of an exterior rear view assembly, in particular for road vehicles.

### BACKGROUND OF THE INVENTION

Vehicles, in particular road vehicles, are required to have exterior rear view systems, which allow the driver to observe the surroundings of the vehicle, which are outside of the driver's peripheral vision. In order to enable the driver to observe the surroundings, the exterior rear view systems are mounted to the exterior of road vehicles. The surroundings of the vehicle include the rear of the vehicle as well as the left and right side of the vehicle. Furthermore, some exterior rear view systems are configured to effectively cover the blind spot(s) of the driver.

Exterior rear view systems usually employ some sort of reflective surface, in particular mirror, or a camera system. Furthermore, exterior rear view systems, especially systems for housing a camera system, are configured to be attached to a vehicle body and carry a multitude of connectors, sensors and/or actuators in order to ensure a proper functionality.

Document DE 10 2021 203 267 B3 describes an exterior rear view assembly, comprising: a base frame comprising a bodywork side surface configured to be attached to a vehicle body. Furthermore, the document describes a seal for such an exterior rear view assembly. The exterior rear view assembly is configured to carry a rear view camera and the base frame is formed as a camera mounting arm. A cable harness may be configured for example as a power supply to the camera and a video signal line from the camera to a vehicle infrastructure.

The individual features of this earlier patent application, filed by the patent applicant of this patent application, are hereby incorporated by reference into the specification of this invention, where and in so-far those of ordinary skill in the art may find it useful that such individual features of this earlier patent application are combined with the features of the invention disclosed herein and/or used to practice the invention disclosed herein.

Document WO 2021 028 245 A1 describes a method for the reliable and error-robust analysis of visually captured vehicle surroundings. A deviation of a camera orientation caused by a force impacting an exterior mirror carrying the camera can be compensated fully automatically. This document describes a method of measuring a positional deviation of a rearview mirror apparatus comprising at least one position sensor from a preset position, capturing the vehicle surround by an imaging sensor integrated in the rearview mirror apparatus, transmitting the positional deviation and the captured vehicle surround to a control unit, and processing the captured vehicle surround by the control unit dependent on the positional deviation. The document also describes a system arrangement for reliable and error-tolerant evaluation of a visually captured vehicle surround, the system arrangement comprising: a rearview mirror apparatus having at least one position sensor configured to measure a positional deviation from a preset position, an imaging sensor configured to capture the vehicle surround, a data interface configured to transfer the positional deviation and the captured vehicle surround to a control unit, and the control unit, which is configured to process the captured vehicle surround dependent on the positional deviation.

This second document in particular describes that a specific position sensor needs to recognize that a faulty setting is present, but it cannot alone trigger a physical adjustment of the mirror. For this, the document describes an additional step based on correction of complete captured images, i.e. the whole image content of captured images needs to be captured and virtually offset in order to finally have enough information to perform the mirror adjustment.

### SUMMARY OF THE INVENTION

In view of the above, an object of the present invention is to provide a new and improved a method of, an arrangement for and data processing program product for determining the orientation of an exterior rear view assembly, in particular for road vehicles.

In accordance with the present invention, the following is provided:
a method of determining the orientation of an exterior rear view assembly with respect to a reference body, in particular a vehicle body, as recited in claim 1 and claim 5 respectively; an arrangement for determining the orientation of an exterior rear view assembly with respect to a reference body, in particular a vehicle body, as recited in claim 8 and claim 12 respectively; and
a data processing program product for determining the orientation of an exterior rear view assembly with respect to a reference body, in particular a vehicle body as recited in claim 15 and 18 respectively.

Advantageous or preferred features of the invention are recited in the dependent claims.

According to one aspect, the present invention provides a method of determining the orientation of an exterior rear view assembly with respect to a reference body—in particular with respect to a vehicle body—wherein:
image data of an image sensor mounted to the exterior rear view assembly or to the reference body is analyzed with respect to technical image data comprising technical image parameter data and/or focusing data and/or non-focusing data,
and an indication for the orientation of the exterior rear view assembly with respect to the reference body and/or an indication for a deviation of the orientation of the exterior rear view assembly with respect to the reference body is derived from the technical image data and/or from deviations of the technical image data.

The afore mentioned method can be configured to work with or in other aspects or embodiments of the invention as described in this document, including the use in an arrangement according to any of the aspects or embodiments as described in this document and the use of the method in the form of a data processing program product according to any of the aspects or embodiments as described in this document.

According to an aspect of the invention, in the method described before, as well as for use in any other embodiment of the invention as described in this document, including in an embodiment in the form of a data processing program product, an edge detection algorithm can be executed with respect to the image data,
focusing data and/or non-focusing data can be derived from the edge detection algorithm, in particular correlated with data of least one image area of the image data, and
an indication for the orientation of the exterior rear view assembly with respect to the reference body and/or an indication for a deviation of the orientation of the exterior rear view assembly with respect to the reference body can derived from the focusing data and/or non-focusing data, in particular correlated with the data of the at least one image area.

According to a further aspect of the invention, in a method as described before, as well as for use in any other embodiment of the invention as described in this document, including in an embodiment in the form of a data processing program product, the technical image parameter data can contain one ore more of the following image parameter data: image blur parameter data and/or image sharpness parameter data, and/or image brightness parameter data, and/or image contrast parameter data, and/or image saturation parameter data.

According to an aspect f the invention, in a method as described before, as well as for use in any other embodiment of the invention as described in this document, including in an embodiment in the form of a data processing program product, an indication for the folding of the exterior rear view assembly towards the reference body, in particular towards a vehicle body, is derived from technical image data correlated with data of an image area where the technical image data characteristic for this image area indicate non-focusing, and/or image blur and/or low image brightness of the first image data.

According to a further aspect, the invention provides a method of determining the orientation of an exterior rear view assembly with respect to a reference body—in particular with respect to a vehicle body-, in particular in combination with any aspect and/or any method as described before, as well as for use in any other embodiment of the invention as described in this document, including in an embodiment in the form of a data processing program product, comprising the steps of:
reading first image data from an image sensor mounted to the exterior rear view assembly or to the reference body;
analyzing the first image data with respect to first technical image data,
comparing the first image data with stored second image data with respect to technical image data and/or comparing the first technical image data with stored second technical image data and/or comparing the first technical image data with stored threshold values of technical image data,
and deriving therefrom the orientation of the exterior rear view assembly with respect to the reference body and/or a deviation of the orientation of the exterior rear view assembly with respect to the reference body.

According to an aspect of the invention, a method according to an embodiment of the invention, in particular a method as described before, as well as a method for use in any other embodiment of the invention as described in this document, including in an embodiment in the form of a data processing program product, can comprise the steps of:
analyzing the image area where at least one technical image data exceeds or falls below a threshold value of the least one technical image data,
and deriving an indication for the orientation of the exterior rear view assembly and/or for a deviation of the orientation of the exterior rear view assembly from the image area and/or from deviations of the image area where at least one technical image data exceeds or falls below such threshold value.

According to an aspect of the invention, a method according to an embodiment of the invention, in particular a method as described before, as well as a method for use in any other embodiment of the invention as described in this document, including in an embodiment in the form of a data processing program product, can comprise the steps of:
analyzing data from at least one data source and/or from at least one sensor, in particular time data and/or position data and/or acceleration data and/or orientation data and/or environmental data with respect to the reference body,
and performing a plausibility check with respect to the technical image data and/or with respect to deviations of the technical image data and/or with respect to the indication for the orientation and/or with respect to the indication for a deviation of the orientation of the exterior rear view assembly with respect to the reference body based on the afore mentioned analysis.

According to a further aspect, the present invention provides an arrangement for determining the orientation of an exterior rear view assembly with respect to a reference body—in particular with respect to a vehicle body—containing:
an image sensor mounted to the exterior rear view assembly or to the reference body,
and a data processing unit, where such a data processing unit can be configured for:
reading image data and/or technical image data from the image sensor,
analyzing technical image data of said image data,
and deriving orientation data which indicates the orientation of the exterior rear view assembly with respect to the reference body from the technical image data and/or deriving deviation data which indicates a deviation of the orientation of the exterior rear view assembly with respect to the reference body from deviations of the technical image data.

Such arrangement can be configured to perform a method according to an embodiment as described before, as well as in the other embodiments of the invention as described in this document, and/or to execute an embodiment in the form of a data processing program product as described in this document.

According to an aspect of the invention, in such arrangement as described before, as well as in the other embodiments of the invention, the data processing unit can be configured for executing an edge detection algorithm with respect to the image data,
for deriving focusing data and/or non-focusing data from the edge detection algorithm, in particular correlated with data of least one image area of the image data,
and for deriving an indication for the orientation of the exterior rear view assembly with respect to the reference body from the focusing data and/or non-focusing data, in particular correlated with the data of the at least one image area,
and/or for deriving an indication for a deviation of the orientation of the exterior rear view assembly with respect to the reference body from the focusing data and/or non-focusing data, in particular correlated with the data of the at least one image area.

According to a further aspect of the invention, in an arrangement as described before, as well as in any other embodiment of the invention, the technical image parameter data can contain one ore more of the following data: image blur parameter data and/or image sharpness parameter data, and/or image brightness parameter data, and/or image contrast parameter data, and/or image saturation parameter data.

According to an aspect of the invention, in an arrangement as described before, as well as in any other embodiment of the invention, the data processing unit can be configured for deriving an indication for the folding of the exterior rear view assembly towards the reference body, in particular towards a vehicle body, from technical image data correlated with data of an image area where the technical image data characteristic for this image area indicate non-focusing, and/or image blur and/or low image brightness of the image data.

According to an aspect of the invention, an arrangement for determining the orientation of an exterior rear view assembly with respect to a reference body—in particular with respect to a vehicle body—according to an embodiment of the invention, in particular an arrangement as described before, as well as in any other embodiment of the invention as described in this document, can—as such or in addition—contain:
a memory unit configured for storing image data and/or technical image data, and
a data processing unit, configured for:
reading image data and/or technical image data and/or threshold value data of technical image data from the image sensor and the memory unit,
analyzing and comparing technical image data and/or threshold value data of technical image data,
and deriving from the comparison orientation data which indicates the orientation of the exterior rear view assembly with respect to the reference body and/or deviation data which indicates a deviation of the orientation of the exterior rear view assembly with respect to the reference body.

According to an aspect of the invention, in an arrangement as described before, as well as in any other embodiment of the invention the data processing unit can be configured for analyzing the image area where at least one technical image data exceeds or falls below a threshold value of the least one technical image data,
and for deriving an indication of the orientation of the exterior rear view assembly and/or for a deviation of the orientation of the exterior rear view assembly from the image area and/or from deviations of the image area where at least one technical image data exceeds or falls below such threshold value.

According to an aspect of the invention, in an arrangement as described before, as well as in any other embodiment of the invention the data processing unit can be connected to at least one data source and/or to at least one sensor for providing time data and/or position data and/or acceleration data and/or orientation data and/or environmental data with respect to the reference body,
and the data processing unit can be configured for:
analyzing time data and/or position data and/or acceleration data and/or orientation data and/or environmental data with respect to the reference body,
and for performing a plausibility check with respect to the technical image data and/or with respect to deviations of the technical image data and/or with respect to the indication for the orientation and/or with respect to the indication for a deviation of the orientation of the exterior rear view assembly with respect to the reference body based on the afore mentioned analysis.

The arrangements described in this document can be combined with individual features of the initially mentioned earlier patent application DE 10 2021 203 267 B3, filed by the patent applicant of this patent application, which are hereby incorporated by reference into the specification of this invention, where and in so-far those of ordinary skill in the art may find it useful that such individual features of this earlier patent application are combined with the features of the invention disclosed herein and/or used to practice the invention disclosed herein.

According to a further aspect, the present invention provides a data processing program product for determining the orientation of an exterior rear view assembly with respect to a reference body—in particular a vehicle body—, comprising instructions which, when the program is executed by a data processing unit, cause the data processing unit to carry out the steps of a method according to any embodiment as described before. The data processing program product can also be configured to work with or in other embodiments of the invention as described in this document, including the use in an arrangement according to any of the embodiments as described in this document.

According to a further aspect, the present invention provides a data processing program product for determining the orientation of an exterior rear view assembly with respect to a reference body, in particular a vehicle body, in particular a data processing program product for use with or according to any of the other embodiments of the invention as described in this document, the data processing program product comprising instructions which, when the program is executed by a data processing unit, cause the data processing unit to carry out the following program step:
a first program step of reading first image data from an image sensor mounted to the exterior rear view assembly or to the reference body,
an intermediate program step of analyzing the first image data with respect to technical image data comprising technical image parameter data and/or focusing data and/or non-focusing data, and
a final program step of deriving orientation data which indicate the orientation of the exterior rear view assembly with respect to the reference body and/or of deriving deviation data which indicate a deviation of the orientation of the exterior rear view assembly with respect to the reference body from the technical image data and/or from deviations of the technical image data.

According to an aspect of the invention, the intermediate program step of an afore mentioned data processing program product according to the invention can comprise
a first intermediate program step of executing an edge detection algorithm with respect to the image data, and
a second intermediate program step of deriving focusing data and/or non-focusing data from the edge detection algorithm, in particular correlated with data of least one image area of the image data,
and wherein the final program step can consist of deriving orientation data which indicate the orientation of the exterior rear view assembly with respect to the reference body and/or of deriving deviation data which indicate a deviation of the orientation of the exterior rear view assembly with respect to the reference body from the focusing data and/or non-focusing data, in particular correlated with the data of the at least one image area.

According to an aspect of the invention, the technical image parameter data treated by the data processing program product in the afore mentioned program steps can contain image blur parameter data, and/or image sharpness parameter data, and/or image brightness parameter data, and/or image contrast parameter data, and/or image saturation parameter data, and/or the final program step can consist of deriving folding indication data which indicate the folding of the exterior rear view assembly towards the reference body, from technical image data correlated with data of an image area where the technical image data characteristic for this image area indicate non-focusing, and/or image blur and/or low image brightness of the image data.

According to a further aspect, the present invention provides a data processing program product for determining the orientation of an exterior rear view assembly with respect to a reference body—in particular a vehicle body—, in particular a data processing program product for use with any of the program steps as described in any of the embodiments before, as well as for use with or according to any of the other embodiments of the invention as described in this document, which can—as such or in addition—comprise instructions which, when the program is executed by a data processing unit, cause the data processing unit to carry out the following program steps:
a first program step of reading first image data from an image sensor mounted to the exterior rear view assembly or to the reference body,
a second program step of analyzing the first image data with respect to first technical image data,
a third program step of reading stored second image data and/or stored second technical image data and/or stored threshold value data of technical image data from a memory unit,
a fourth program step of comparing the first image data with stored second image data with respect to technical image data and/or comparing the first technical image data with stored second technical image data and/or comparing the first technical image data with stored threshold values of technical image data,
and a fifth program step of deriving from the comparison orientation data which indicates the orientation of the exterior rear view assembly with respect to the reference body and/or deviation data which indicates a deviation of the orientation of the exterior rear view assembly with respect to the reference body.

According to an aspect of the invention, a data processing program product according to the invention can comprise instructions which, when the program is executed by a data processing unit, cause the data processing unit to carry out the following further program steps:
a first further program step of analyzing data from at least one data source and/or from at least one sensor, in particular time data and/or position data and/or acceleration data and/or orientation data and/or environmental data with respect to the reference body;
second further program step of performing a plausibility check with respect to the technical image data and/or with respect to deviations of the technical image data and/or with respect to the orientation data and/or with respect to the deviation data based on the afore mentioned analysis; and
a third further program step of outputting a result message to a user and/or storing result data in a memory unit based on the result of the afore mentioned plausibility check.

The embodiments described above can be combined with each other as desired, if useful. Further possible embodiments, further configurations and implementations of the invention also include combinations, not explicitly mentioned, of features of the invention described herein with respect to the embodiments. In particular, the skilled person will thereby also add individual aspects as improvements or additions to the respective basic form of the present invention.

### BRIEF DESCRIPTION OF THE DRAWINGS

For a more comprehensive understanding of the invention and the advantages thereof, exemplary embodiments of the invention are explained in more detail in the following description with reference to the accompanying figures, in which like reference characters designate like parts and in which the following is shown:

FIG. 1 a schematic view of an image capturing device according to an embodiment of the invention;

FIG. 2a a schematic view of an exterior rear view assembly comprising an image capturing device according to an embodiment of the invention, where the exterior rear view assembly is shown in a first orientation (use orientation) relative to a reference body, in particular to a vehicle body;

FIG. 2b a schematic view of an exterior rear view assembly comprising an image capturing device according to the embodiment of FIG. 2a, where the exterior rear view assembly is shown in a second orientation (folded orientation) relative to a reference body, in particular to a vehicle body;

FIG. 3a a schematic view of image data captured by an image capturing device of an exterior rear view assembly according to an embodiment in a first orientation relative to a reference body, such as according to FIG. 2a;

FIG. 3b a schematic view of image data captured by an image capturing device of an exterior rear view assembly according to an embodiment in a second orientation relative to a reference body, such as according to FIG. 2b;

FIG. 4a a schematic view of a sharp edge intensity distribution over distance in captured image data, such as at sharp edges according to FIGS. 3a and 3b;

FIG. 4b a schematic view of a blurred edge intensity distribution over distance in captured image data, such as at blurred edges according to FIGS. 3a and 3b;

FIG. 5 a schematic view of an arrangement for determining the orientation of an exterior rear view assembly with respect to a reference body, in particular a vehicle body according to an embodiment of the invention;

FIG. 6 a schematic flow diagram of subsequent steps of a method, realized by means a data processing program product, for determining the orientation of an exterior rear view assembly according to an embodiment of the invention.

FIG. 7 a schematic flow diagram of subsequent steps of a method, realized by means of a data processing program product, for determining the orientation of an exterior rear view assembly according to a further embodiment of the invention.

The accompanying drawings are included to provide a further understanding of the present invention and are incorporated in and constitute a part of this specification. The drawings illustrate particular embodiments of the invention and together with the description serve to explain the principles of the invention. Other embodiments of the invention and many of the attendant advantages of the invention will be readily appreciated as they become better understood with reference to the following detailed description.

It will be appreciated that common and/or well understood elements that may be useful or necessary in a commercially feasible embodiment are not necessarily depicted in order to facilitate a more abstracted view of the embodiments. The elements of the drawings are not necessarily illustrated to scale relative to each other. It will further be appreciated that certain actions and/or steps in an embodiment of a method may be described or depicted in a particular order of occurrences while those skilled in the art will understand that such specificity with respect to sequence is not actually required. It will also be understood that the terms and expressions used in the present specification have the ordinary meaning as is accorded to such terms and expressions with respect to their corresponding respective areas of technology, except where specific meanings have otherwise been set forth herein.

### DETAILED DESCRIPTION OF EMBODIMENTS

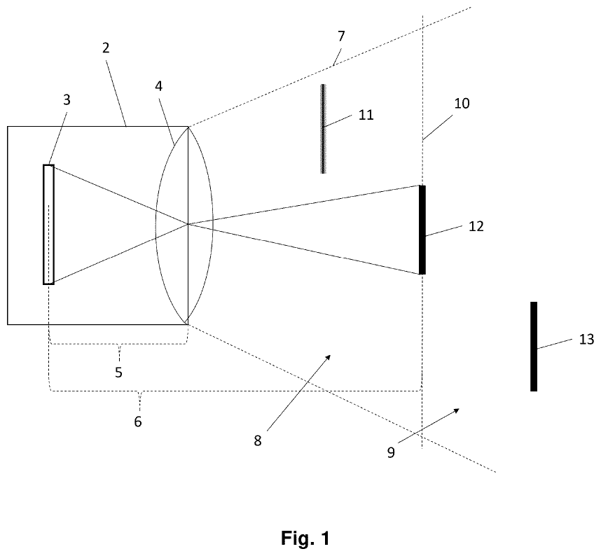

With reference to FIG. 1 of the drawings, an image capturing device 2 is schematically shown in part, where the image capturing device 2 in particular contains an image sensor 3 and a lens 4.

The distance between image sensor 3 and lens 4 is the focal length 5 of the image capturing device 2. The minimum focusing distance 6—also called minimum object distance (MOD)—of the image capturing device 2 is also shown in FIG. 1 and is another characteristic of an image capturing device 2. The minimum focusing distance 6 defines a minimum focusing distance plane 10—which can also be called minimum object distance (MOD) plane. The minimum focusing distance 6 of an image capturing device 2 depends on the focal length 5 of the lens 4 or lens system, i.e. of the optical system of the image capturing device 2.

An image capturing device 2 according to FIG. 1 can be part of an exterior rear view assembly 1 containing a camera device as described with respect to the following figures, i.e. it can be part of a Digital Rearview Mirror system, in particular of a Camera Monitor System (CMS) mounted to a vehicle body, which serves as a reference body 20 in the sense of the invention disclosed herein. For a CMS system, it is necessary to determine the orientation of the CMS system with respect to a vehicle body, in particular to provide a folding detection. In the prior art as mentioned above, different solutions with extra sensors and/or using complex image evaluation algorithms are known.

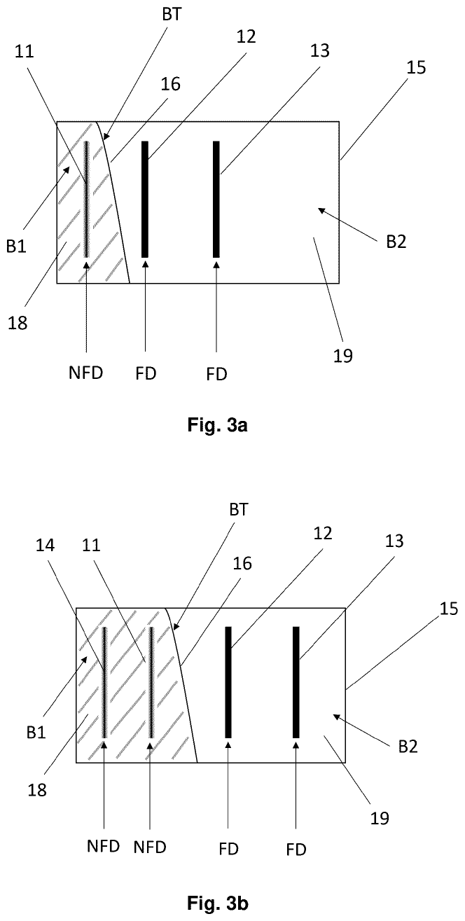

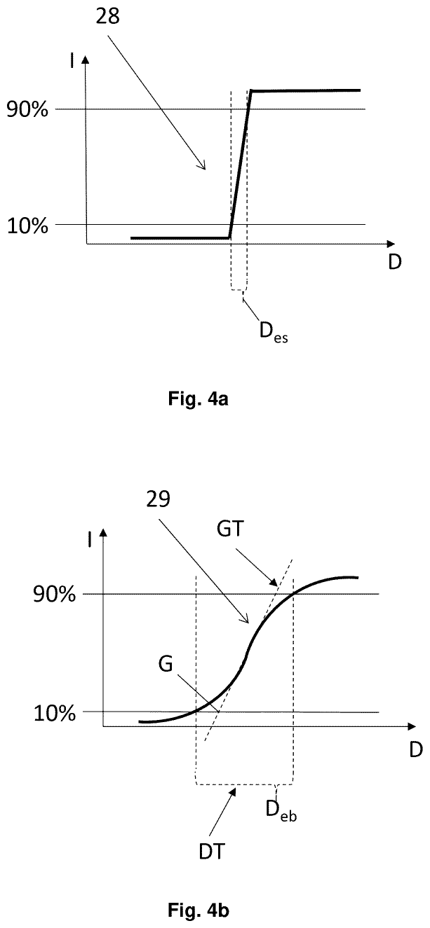

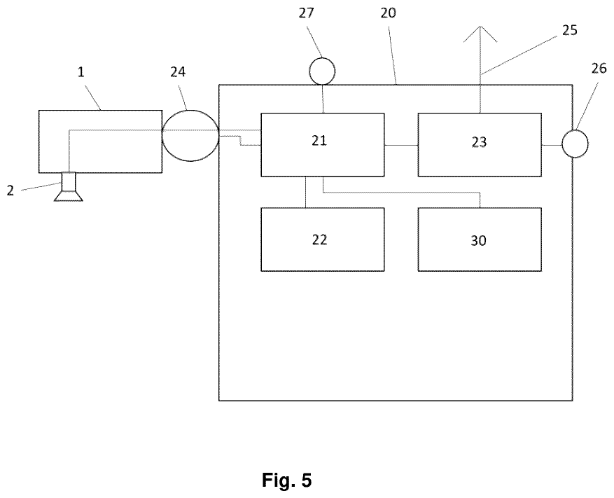

With reference to FIG. 1, the field of view 7 of the image capturing device 2, the lens 4 and the minimum focusing distance plane 10 enclose a spatial non-focusing area or “blur area” 8 (in the following designated as “non-focusing/blur area 8”), i.e. a spatial area in which first objects and/or contours 11 (in the following designated as “first object/contour 11”) cannot be focused by the image capturing device 2. An edge detection algorithm, which can be realized by means of a data processing program product executed by a data processing unit 21 as shown in FIG. 5, cannot find edges of the first object/contour 11 to focus on the first object/contour 11. As a consequence, in the resulting image data 15 captured by the image sensor 3—as shown in FIG. 3a and FIG. 3b—, the image capturing device 2 cannot focus on the first object/contour 11, so it will be captured as blurred object/contour 11, which may have a blurred edge intensity distribution 29 as shown and described with reference to FIG. 4b.

In a spatial focusing area 9 or “sharpness area” (in the following designated as “focusing/sharpness area 9”) outside the minimum focusing distance plane 10, i.e. an area 9 limited by and including the minimum focusing distance plane 10, second and third objects and/or contours 12, 13 (in the following designated as “second/third object/contour 12, 13”) can be focused by the image capturing device 2 and will produce a respective focused and sharp object/contour 12, 13 in the image data 15 captured by the image sensor 3, as will be explained in the following description.

So when a second object/contour 12 has a distance to the image sensor 3 equal to the minimum focusing distance 6, then the image capturing device 2 can still focus on that second object/contour 12, as far as the object/contour lies in or beyond the minimum focusing distance plane 10. An edge detection algorithm, which can be realized by means of a data processing program product executed by a data processing unit 21 as shown in FIG. 5, can find edges of the second object/contour 12 to focus on the second object/contour 12.

As a consequence, in the resulting image data 15 captured by the image sensor 3—as shown in FIG. 3a and FIG. 3b—, the second object/contour 12 can be captured as sharp object/contour 12, which may have a sharp edge intensity distribution 28 as shown in FIG. 4a, as far as the second object/contour 12 lies in the minimum focusing distance plane 10.

When a third object/contour 13 entirely has a distance to the image sensor 3 bigger than the minimum focusing distance 6, then the image capturing device 2 can focus on the entire third object/contour 13. As a consequence, in the resulting image data 15 captured by the image sensor 3—as shown in FIG. 3a and FIG. 3b—, the entire third object/contour 13 can be captured as sharp object/contour 13, which may have a sharp edge intensity distribution 28 as is shown and described with reference to FIG. 4a.

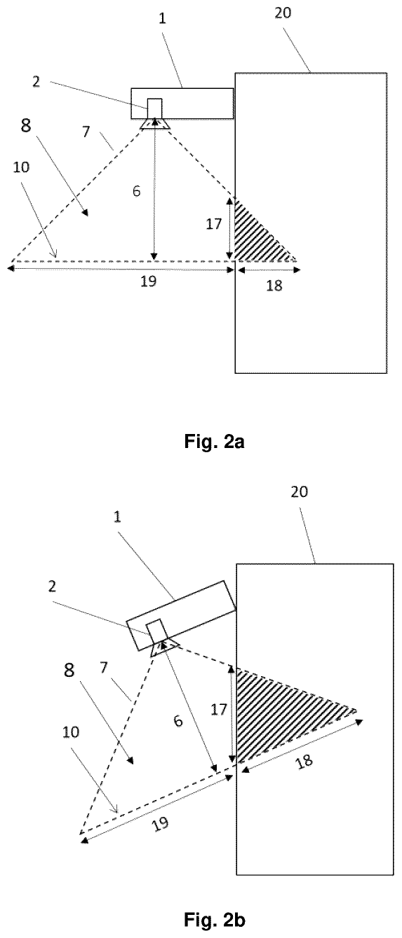

With reference to FIG. 2a, a schematic view of an exterior rear view assembly 1 comprising an image capturing device 2 according to an embodiment of the invention is shown, where the exterior rear view assembly 1 is shown in a first orientation (use orientation), i.e. a non-folded orientation relative to a reference body 20, in particular to a vehicle body. The minimum focusing distance 6 of the image capturing device 2 is also shown in FIG. 2a. The minimum focusing distance 6 defines a minimum focusing distance plane 10, as already described with reference to FIG. 1.

An image sensor (not shown in FIG. 2a) of the image capturing device 2—corresponding to an image sensor 3 as shown in FIG. 1—which is mounted to the exterior rear view assembly 1, will capture image data 15 as shown schematically in FIG. 3a. This image data 15 of the image sensor is analyzed by a data processing unit 21 as shown in FIG. 5 with respect to technical image data Dₑₛ, D_{eb}, G, B1, B2, 28, 29, FD, NED. Such technical image data Dₑₛ, D_{eb}, G, B1, B2, 28, 29, FD, NED can on the one hand comprise technical image parameter data Dₑₛ, D_{eb}, G, B1, B2, 28, 29, i. e. data that represent image blur parameters D_{eb}, G, 29 and/or data that represent image sharpness parameters Dₑₛ, G, 28, and/or data that represent image brightness parameters B1, B2, and/or data that represent image contrast parameters, and/or data that represent image saturation parameters. Such technical image parameter data Dₑₛ, D_{eb}, G, B1, B2, 28, 29 can relate to characteristics of one or more image areas 18, 19 of the image data 15.

On the other hand, the technical image data can contain focusing data FD and/or non-focusing data NFD. Such focusing data FD and/or non-focusing data NFD can be derived from an edge detection algorithm as mentioned before, and in particular can be correlated with data of and/or descriptive for least one image area 18, 19 of the image data 15, as will be explained in more detail with respect to the following figures.

The afore mentioned at least one image area 18, 19 can be a fraction of the total area of the image data 15, or can be the entire area of the image data 15.

With reference to FIG. 2a, the field of view 7 of the image capturing device 2 between the front lens (not shown) of the image capturing device 2 and the minimum focusing distance plane 10 again enclose a non-focusing/blur area 8 as already described with reference to FIG. 1, i.e. a spatial area in which objects and/or contours cannot be focused by the image capturing device 2. As a consequence, in the image data 15 captured by the image sensor (not shown) of the image capturing device 2, the image capturing device 2 cannot focus on the range 17 of the reference body 20, which is consequently a non-focusing/blur range 17 of the reference body 20, i particular of a vehicle body, as this non-focusing/blur range 17 lies within the non-focusing/blur area 8.

This means that an edge detection algorithm, which can be realized by means of a data processing program product executed by a data processing unit 21 as shown in FIG. 5, cannot find edges of the reference body 20—such as a vehicle body—in this non-focusing/blur range 17. As a consequence, the image capturing device 2 cannot focus on the non-focusing/blur range 17 of the reference body 20 that lies within the field of view 7 of the image capturing device 2 and within the non-focusing/blur area 8. So the projected view of this non-focusing/blur range 17 of the reference body 20—such as of the vehicle body—will be captured by the image sensor 3 of the image capturing device 2 in image data 15 as a projected non-focusing/blurred first image area 18, as shown schematically in FIG. 3a.

All the contours/objects 11 in this projected non-focusing/blurred first image area 18 of the image data 15 are non-focused/blurred, and the intersection of the minimum focusing distance plane 10 with the reference body 20, i.e. with the vehicle body defines a threshold value line 16 which separates the projected non-focusing/blurred first image area 18 from a second image area 19 that is captured as a projected focusing/sharpness second image area 19.

Based on the result of the edge detection algorithm performed by the data processing unit 21 by means of a data processing program product, the data processing unit 21 generates a data output comprising focusing data FD and/or non-focusing data NFD, derived from the edge detection algorithm. In particular, such data output comprising focusing data FD and/or non-focusing data NFD can be correlated with data of at least one image area 18, 19 of the image data 15, such as data about the size and/or deviation of size of the at least one image area 18, 19.

In particular, the data processing unit 21 can generate a data output comprising non-focusing data NFD correlated with data about the size and/or deviation of size of a first image area 18 for which an edge detection algorithm, which can be realized by means of a data processing program product executed by a data processing unit 21 as shown in FIG. 5, cannot find edges and cannot focus on such edges of the reference body 20—such as a vehicle body. Alternatively or in addition, the data processing unit 21 can generate a data output comprising focusing data FD correlated with data about the size and/or deviation of size of a second image area 19 for which an edge detection algorithm, which can be realized by means of a data processing program product executed by a data processing unit 21 as shown in FIG. 5, can find edges and can focus on such edges of the reference body 20—such as a vehicle body.

The data processing unit 21 can then—by means of a data processing program product—derive from the focusing data FD and/or non-focusing NFD data—in particular correlated with the data of the at least one image area 18, 19—an indication or indication data characteristic for the orientation of the exterior rear view assembly 1 with respect to the reference body 20 and/or an indication or indication data characteristic for a deviation of the orientation of the exterior rear view assembly 1 with respect to the reference body 20. Respective result data and/or a result message is created by the data processing unit 21 and is displayed to a user by means of a user interface unit 30 and/or stored in a memory unit 22.

Alternatively or in addition, the image brightness of the afore mentioned range 17 can be lower than the image brightness of the other areas in the field of view 7 of the image capturing device 2. This means that the image brightness parameter value B1 (in particular an average image brightness parameter value B1) in the projected first image area 18 of the image data 15 can be lower than the image brightness parameter value B2 (in particular an average image brightness parameter value B2) in the second image area 19. As a consequence, the image brightness parameter value data B1, B2 can fall below a threshold value BT at one or more threshold value lines 16, which then separate one or more projected low brightness first image area 18 from one or more projected high brightness second image area 19 in the captured image data 15.

Alternatively or in addition, image blur parameter data D_{eb}, G, 29 and/or image sharpness parameter data Dₑₛ, G, 28, and/or image contrast parameter data, and/or image saturation parameter data can also differ in the projected first image area 18 from such data values in the second image area 19, and can exceed or fall below a respective threshold value DT, GT at one or more threshold value lines 16, and can therefore be used as alternative or additional indicators for the orientation of the exterior rear view assembly 1 relative to the reference body 20, in particular to a vehicle body. Respective result data and/or a result message can be created by the data processing unit 21 and can be displayed to a user by means of a user interface unit 30 and/or stored in a memory unit 22.

The threshold values BT, DT, GT—and any other comparable threshold value—can be a predefined threshold value BT, DT, GT stored in a memory unit 22 as shown in FIG. 5. Alternatively or in addition, the threshold value BT, DI, GT—and any other comparable threshold value—can be derived from the respective parameter value data of the second image area 19 of the image data 15. The image brightness threshold value BT can for example be derived as average image brightness parameter value data BT from the brightness parameter value data of the second image area 19 of the image data 15.

The use of the invention in a CMS system as a specific exterior rear view assembly 1 allows to have a folding detection for a CMS system with respect to a vehicle body as reference body 20. If the CMS Wing folds down in the direction of the vehicle, as schematically shown in FIG. 2b, the minimum distance, which the camera needs to be able to focus, is no longer achieved. If it is no longer possible to focus, an edge detection can no longer find any edges.

As generally described above, there is also the possibility that in the CMS system is tracked whether the area shifts in which the CMS camera as a specific image capturing device 2 can not focus. Usually the camera is mounted so close to the vehicle that a part of the camera field of view 7 does not reach the minimum focus distance 6, as schematically shown in FIG. 2a. In common CMS systems, the minimum focusing distance 6 is typically less than 1m, and can be in a range of 0.5 m-1.0 m, in particular in a range of 0.6m-0,8 m. In common CMS systems, the field of view 7 is typically less than 120°, and can be in a range of 500-1000, in particular in a range of 60°-90°, for example 70°. When the CMS Wing carrying the CMS camera is folded down, then the area shifts in which the CMS camera as a specific image capturing device 2 cannot focus, and from a determination of the deviation or shift of such area, the CMS system can determine whether the CMS Wing is in the use orientation, i.e. in a non-folded or driving position or is in a different orientation, such as in a folded position and/or in which direction the CMS wing has shifted.

As also generally described above, the detected brightness can be or become significantly low or lower, especially in the area that is closer to the vehicle body, while (relative to the afore mentioned detected lower brightness) the detected brightness stays or becomes potentially brighter to the other side, distant from the vehicle body. From this, the system can conclude that the CMS Wing is in the folded-down position.

However, there may be situations where the CMS system can no longer detect edges, however the CMS Wing is not necessarily folded down. It may be dark in the environment of the vehicle body and/or the lens of the CMS system may be dirty and/or there may be another defect of the CMS system. In order not to make a wrong decision, a plausibility check can be performed by a data processing unit 21, by means of a respective data processing program product, as provided in one of the embodiments of the invention, and as will be described in more detail in the following description. In order to be able to verify the decision that the CMS Wing is folded down, additional data and/or factors can taken into account such as: time of day, GPS position data, data concerning brightness values from a brightness sensor of the vehicle and/or data concerning brightness values of other cameras mounted to the vehicle body, such as of one or more Surround View System (SVS) cameras. If the plausibility check shows that the wing has folded down, a respective message is displayed to a user by means of a user interface unit 30 and/or stored in a memory unit 22.

With reference to a more general representation as shown in FIG. 2b, a schematic view of an exterior rear view assembly 1 comprising an image capturing device 2 according to the embodiment of FIG. 2a is shown, where the exterior rear view assembly 1 is now shown in a second orientation (folded orientation) relative to the reference body 20, in particular to a vehicle body.

Again, the field of view 7 of the image capturing device 2 between the front lens (not shown) of the image capturing device 2 and the minimum focusing distance plane 10 enclose an non-focusing/blur area 8 as already described with reference to FIG. 2a, i.e. a spatial area in which an edge detection algorithm, which can be realized by means of a data processing program product executed by a data processing unit 21 as shown in FIG. 5, cannot find edges and/or in which objects and/or contours cannot be focussed by the image capturing device 2. However, now the orientation of the exterior rear view assembly 1 comprising an image capturing device 2 relative to the reference body 20—such as relative to a vehicle body-has shifted.

As a consequence, the image sensor (not shown) of the image capturing device 2 will now capture different technical image data Dₑₛ, D_{eb}, G, B1, B2, 28, 29, FD, NFD and/or deviations of technical image data Dₑₛ, D_{eb}, G, B1, B2, 28, 29, FD, NED with respect to second image data 15, as shown schematically in FIG. 3b. In particular, the image sensor (not shown) of the image capturing device 2 may capture different data and/or deviations of data of technical image parameters Dₑₛ, D_{eb}, G, B1, B2, 28, 29 i.e. different data and/or deviations of data that represent image blur parameters D_{eb}, G, 29 and/or image sharpness parameters Dₑₛ, G, 28, and/or image brightness parameters B1, B2, and/or image contrast parameters, and/or image saturation parameters. Such different and/or deviating technical image parameter data Dₑₛ, D_{eb}, G, B1, B2, 28, 29 can again relate to characteristics of one or more image areas 18, 19 of the image data 15.

The image sensor (not shown) of the image capturing device 2 may alternatively or in addition capture different focusing data FD and/or non-focusing NFD and/or deviations of focusing data FD and/or non-focusing NFD data, which in particular can be correlated with data of and/or descriptive for least one image area 18, 19 of the image data 15, as shown in FIG. 3a and FIG. 3b, and the data processing unit 21 can-by means of a data processing program product-derive from the focusing data FD and/or non-focusing NFD data, in particular correlated with the data of the at least one image area 18, 19 an indication for the orientation of the exterior rear view assembly 1 with respect to the reference body 20 and/or an indication for a deviation of the orientation of the exterior rear view assembly 1 with respect to the reference body 20, and as already described above with reference to FIG. 2a.

This means that such different technical image data Dₑₛ, D_{eb}, G, B1, B2, 28, 29, FD, NFD and/or deviations of such technical image data Dₑₛ, D_{eb}, G, B1, B2, 28, 29, FD, NFD can provide an indication for the orientation of the exterior rear view assembly 1 with respect to the reference body 20 and/or an indication for a deviation of the orientation of the exterior rear view assembly 1 with respect to the reference body 20.

With reference to FIG. 2b, the image capturing device 2 again cannot focus on the non-focusing/blur range 17 of the reference body 20, in particular of a vehicle body. However, due to the deviation of the orientation of the exterior rear view assembly 1 relative to the reference body 20, i.e. to the vehicle body, in particular due to a folding of the exterior rear view assembly 1 towards the reference body 20—in particular to a vehicle body-the extent of the non-focusing/blur range 17 of the reference body 20—in particular of a vehicle body—has increased.

As a consequence, the projected view of this non-focusing/blur range 17 of the reference body 20—in particular of a vehicle body—will be captured by the image sensor of the image capturing device 2 in second image data 15 as a bigger projected non-focusing/blurred first image area 18, as shown schematically in FIG. 3b. In such second image data 15, more non-focused/blurred contours/objects 11, 14 of the reference body 20—such as of a vehicle body—will now appear in this larger projected non-focusing/blurred first image area 18 of the second image data 15, and the intersection of the minimum focusing distance plane 10 with the reference body 20—i.e. with the vehicle body—defines a shifted threshold value line 16, which separates the projected non-focusing/blurred first image area 18 from a projected focusing/sharpness second image area 19.

The deviation of the orientation of the exterior rear view assembly 1 (folded orientation) relative to the reference body 20, in particular to a vehicle body, can even lead to the effect, that in the whole second image data 15, the image capturing device 2 cannot focus on any object/contour any more, when the non-focusing/blur range 17 of the reference body 20 fully covers the field of view 7 of the image capturing device 2. In that case, an edge detection algorithm, which can be realized by means of a data processing program product executed by a data processing unit 21 as shown in FIG. 5, cannot find any edges of the reference body 20 in the whole second image data 15, i.e. the projected non-focusing/blurred first image area 18 is identical to the whole area of the second image data 15. Consequently, when the edge detection algorithm cannot find any edges in the second image data 15, this can be an indication for a complete folding of the exterior rear view assembly 1 with respect to the reference body 20.

So deviations of the projected non-focusing/blurred first image area 18 and/or of the projected focusing/sharpness second image area 19 and/or the threshold value line 16 will be captured, and such deviations are each and/or together an indication for the deviation of the orientation of the exterior rear view assembly 1 relative to the reference body 20.

Alternatively or in addition, the projected view of the bigger range 17 of the reference body 20 having lower image brightness value B1 will be captured by the image sensor of the image capturing device 2 in second image data 15 as a bigger low brightness first image area 18, as also shown schematically in FIG. 3b. So deviations of the projected low image brightness first image area 18 and/or of the projected high image brightness second image area 19 and/or of the image brightness threshold value line 16 of image brightness threshold value BT will be captured, and such deviations can be each and/or together an additional or alternative indication for the deviation of the orientation of the exterior rear view assembly 1 relative to the reference body 20.

As described above, FIG. 4a shows a schematic view of a sharp edge intensity distribution 28 of intensity I over the distance D in image data 15—such as at sharp edges of the objects/contours 12, 13 as shown in FIGS. 3a and 3b. FIG. 4b shows a schematic view of a blurred edge 29 intensity distribution I over the distance D in image data 15—such as at blurred edges of the objects/contours 11, 14 as shown in FIGS. 3a and 3b.

The sharpness of an edge of objects/contours 11, 12, 13, 14 in image data 15 and/or an indication if an image capturing device 2 has focused on such objects/contours 11, 12, 13, 14 is defined by and/or can be detected from the following image blur and/or image sharpness parameters: the intensity rise distance Dₑₛ, Deb which is usually defined as the distance D of a rise of the intensity I at an edge of an object/contour 11, 12, 13, 14 from 10% to 90% and/or the gradient G of the rise of the intensity I over distance D.

When the before mentioned technical image parameters and/or characteristics Dₑₛ, D_{eb}, G, 28, 29 of the image data 15 exceed or fall below a respective threshold value DT, GT of the least one technical image parameter, then the image capturing device 2 can no longer focus objects/contours 11, 12, 13, 14. In particular, technical image parameters and/or characteristics Dₑₛ, D_{eb}, G, 28, 29 of the image data 15 exceed or fall below a threshold value of the least one technical image parameter when e.g. the rise distance Dₑₛ, Deb exceeds a threshold value DT and/or when the gradient G of the rise of the intensity I over distance D falls below a threshold value GT, such that the image capturing device 2 can no longer focus on objects/contours 11, 12, 13, 14 and/or an edge detection algorithm as described before can no longer find edges in the image data 15.

Depending on the orientation of the image capturing device 2 and depending on the minimum focusing distance 6 of the image capturing device 2, there can be one or more image areas 18, 19 of the image data 15 which define one or more threshold value lines 16 where technical image parameters and/or characteristics Dₑₛ, D_{eb}, G, 28, 29 of the image data 15 exceed or fall below a threshold value of the least one technical image parameter, as shown in FIG. 3a and FIG. 3b. This one or more threshold value lines 16 separate one or more projected non-focusing/blurred image areas 18 from one or more projected focusing/sharpness image areas 19 in the captured image 15.

From the afore mentioned description of the principles and possible embodiments of the invention, it gets clear, that the invention does not refer to or rely on the image content of the image data 15 captured by the image sensor 3. This means that complex image recognition techniques or the like on the one hand and additional position sensors for camera systems on the other hand can be avoided.

FIG. 5 schematically shows an arrangement for determining the orientation of an exterior rear view assembly 1 with respect to a reference body 20, in particular a vehicle body, according to an embodiment of the invention. The arrangement contains an image capturing device 2 which contains an image sensor (not shown) and which is mounted to the exterior rear view assembly 1. The exterior rear view assembly 1 in particular forms a Digital Rearview Mirror system, in particular a Camera Monitor System (CMS) mounted to a vehicle body which serves as a reference body 20 in the sense of the invention disclosed herein. The exterior rear view assembly 1 is connected to the reference body 20, i.e. to the vehicle body, by means of an exterior rear view assembly orientation unit 24, which can include a motor and/or one or more articulation axes.

The image capturing device 2, in particular the image sensor of the image capturing device 2, has a data connection to a data processing unit 21, which has a data connection to a memory unit 22. The data processing unit 21 also has a data connection to at least one data source 23, 25, 26 and/or to at least one sensor 27 for providing time data and/or position data and/or acceleration data and/or orientation data and/or environmental data with respect to the reference body 20.

The data processing unit 21 is configured for reading image data 15 and/or technical image data Dₑₛ, D_{eb}, G, B1, B2, 28, 29, FD, NFD from an image sensor of the image capturing device, such as the image sensor 3 according as shown in FIG. 1, for analyzing technical image data Dₑₛ, D_{eb}, G, B1, B2, 28, 29, FD, NFD of said image data 15, and for deriving orientation data which indicates the orientation of the exterior rear view assembly 1 with respect to the reference body 20, i.e. with respect to the vehicle body, from the technical image data Dₑₛ, D_{eb}, G, B1, B2, 28, 29, FD, NED and/or for deriving deviation data which indicate a deviation of the orientation of the exterior rear view assembly 1 with respect to the reference body 20 from deviations of the technical image data Dₑₛ, Debr G, B1, B2, 28, 29, FD, NFD, in particular using data, methods and data processing program products as described with respect to the FIGS. 1 to 4b, FIG. 6 and FIG. 7.

In particular, the data processing unit 21 is configured for deriving folding orientation data which indicates the folding of the exterior rear view assembly 1 towards the reference body 20, i.e. towards the vehicle body, from the technical image data Dₑₛ, D_{eb}, G, B1, B2, 28, 29, FD, NED and/or from deviations of the technical image data Dₑₛ, D_{eb}, G, B1, B2, 28, 29, FD, NFD.

According to the embodiment of FIG. 5, the at least one data source 23, 25, 26 comprises a communication unit 23 which has a data connection to the data processing unit 21, and which has a data connection to o a wireless receiver unit 25, configured for wireless data exchange, and/or to an interface unit 26, configured for wire-based data exchange. This data source 23, 25, 26 can deliver to the data processing unit 21 data relating to the position of the reference body 20, relating to the time (time of day, day of the year) at the position of the reference body 20, relating to the brightness and/or relating to weather conditions at the position of the reference body 20 and any other useful environmental data with respect to the reference body 20.

In addition, at least one sensor 27 has a data connection to the data processing unit 21. Such sensor 27 can be an optical sensor, such as a brightness detection sensor or camera sensor, e.g. of a front camera, a rear camera, a parking system camera, a safety vision system camera or a Surround View System (SVS) camera; a temperature sensor; a rain sensor; a position sensor, such as a GPS sensor, and any other useful environmental sensor mounted to the reference body 20.

The afore mentioned data from a data source 23, 25, 26 and/or from at least one sensor 27 can be used by the data processing unit 21 to perform a plausibility check with respect to the technical image data Dₑₛ, D_{eb}, G, B1, B2, 28, 29, FD, NED and/or with respect to deviations of the technical image data Dₑₛ, D_{eb}, G, B1, B2, 28, 29, FD, NFD and/or with respect to derived indication data for the orientation of the exterior rear view assembly 1 with respect to the reference body 20 and/or with respect to derived deviation data indicating a deviation of the orientation of the exterior rear view assembly 1 with respect to the reference body 20.

Such plausibility check can be performed to verify if the finding is correct that the orientation of the exterior rear view assembly 1 with respect to the reference body 20 has changed, i.e. that a deviation of the orientation f the exterior rear view assembly 1 with respect to the reference body 20 has been detected. As already mentioned before, a deviation of the orientation of the exterior rear view assembly 1 with respect to the reference body 20 must not necessarily have happened, in particular the exterior rear view assembly 1 is not necessarily folded towards the reference body 20. It may be dark in the environment of the reference body 20, or the lens of the image capturing device 2 may be dirty or covered with rain, mud, snow of ice, or there may be another defect of the image capturing device 2. In order not to make a wrong decision, such plausibility check can be performed by the data processing unit 21.

If the plausibility check shows a high plausibility that a deviation of the orientation of the exterior rear view assembly 1 with respect to the reference body 20 has been detected, in particular that the exterior rear view assembly 1 is folded towards the reference body 20, plausibility check result data and/or a plausibility check result message and/or a respective confirmation result message can be created by the data processing unit 21 and can be displayed to a user by means of a user interface unit 30 and/or can be stored in a memory unit 22.

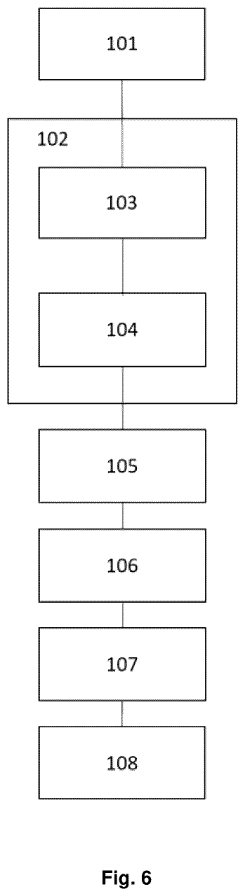

With reference to FIG. 6, a schematic flow diagram of subsequent steps of a method, realized by means a data processing program product, for determining the orientation of an exterior rear view assembly according to an embodiment of the invention is shown. In particular, FIG. 6 shows the schematic flow diagram according to a first embodiment of a data processing program product for determining the orientation of an exterior rear view assembly 1 with respect to a reference body 20, in particular a vehicle body, comprising instructions which, when the program is executed by the afore mentioned data processing unit 21, cause the data processing unit 21 to carry out the following program steps as schematically shown in FIG. 6:
a first program step 101 of reading first image data 15 from an image sensor 3 mounted to the exterior rear view assembly 1 or to the reference body 2;
an intermediate program step 102 of analyzing the first image data 15 with respect to technical image data Dₑₛ, D_{eb}, G, B1, B2, 28, 29, FD, NFD comprising technical image parameter data Dₑₛ, D_{eb}, G, B1, B2, 28, 29 and/or focusing data FD and/or non-focusing data NFD; and
a final program step 105 of deriving orientation data which indicate the orientation of the exterior rear view assembly 1 with respect to the reference body 20 and/or deviation data which indicate a deviation of the orientation of the exterior rear view assembly 1 with respect to the reference body 20 from the technical image data Dₑₛ, D_{eb}, G, B1, B2, 28, 29 FD, NFD and/or from deviations of the technical image data Dₑₛ, D_{eb}, G, B1, B2, 28, 29, FD, NFD.

Such data processing program product can be further adapted by including further steps or features of further embodiments as described in this document and/or for use in any arrangement as described in this document.

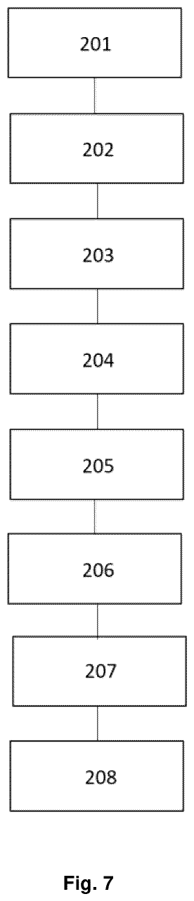

With reference to FIG. 7, a schematic flow diagram of subsequent steps of a method, realized by means of a data processing program product, for determining the orientation of an exterior rear view assembly according to a further embodiment of the invention is shown. In particular, FIG. 7 shows the schematic flow diagram according to a second embodiment of a data processing program product for determining the orientation of o an exterior rear view assembly 1 with respect to a reference body 20, in particular a vehicle body, comprising instructions which, when the program is executed by a data processing unit 21, cause the data processing unit 21 to carry out the following program steps:
a first program step 201 of reading first image data 15 from an image sensor 3 mounted to the exterior rear view assembly 1 or to the reference body 20;
a second program step 202 of analyzing the first image data 15 with respect to first technical image data Dₑₛ, D_{eb}, G, B1, B2, 28, 29, FD, NFD;
a third program step 203 of reading stored second image data 15 and/or second technical image data Dₑₛ, D_{eb}, G, B1, B2, 28, 29, FD, NED and/or stored threshold value data BT, DT, GT of technical image data Dₑₛ, D_{eb}, G, B1, B2, 28, 29, FD, NED from a memory unit 22;
a fourth program step 204 of comparing the first image data 15 with stored second image data 15 with respect to technical image data Dₑₛ, D_{eb}, G, B1, B2, 28, 29, FD, NED and/or comparing the first technical image data Dₑₛ, D_{eb}, G, B1, B2, 28, 29, FD, NED with stored second technical image data Dₑₛ, D_{eb}, G, B1, B2, 28, 29, FD, NFD and/or comparing the first technical image data Dₑₛ, D_{eb}, G, B1, B2, 28, 29, FD, NFD with stored threshold values BT, DT, GT of technical image data Dₑₛ, D_{eb}, G, B1, B2, 28, 29, FD, NFD; and
a fifth program step 205 of deriving from the comparison orientation data which indicates the orientation of the exterior rear view assembly 1 with respect to the reference body 20 and/or deviation data which indicates a deviation of the orientation of the exterior rear view assembly 1 with respect to the reference body 20.

Also such second data processing program product can be further adapted by including further steps or features of further embodiments as described in this document and/or for use in any arrangement as described in this document.

In both afore mentioned figures, i.e. in FIG. 6 and FIG. 7, additional program steps are schematically shown, relating to a plausibility check to be performed by means of such data processing program product, comprising instructions which, when the program is executed by a data processing unit 21, cause the data processing unit 21 to carry out the following further program steps:
a first further program step 106, 206 of analyzing data from at least one data source 23, 25, 26 and/or from at least one sensor 27, in particular time data and/or position data and/or acceleration data and/or orientation data and/or environmental data with respect to the reference body 20;
a second further program step 107, 207 of performing a plausibility check with respect to the technical image data Dₑₛ, D_{eb}, G, B1, B2, 28, 29, FD, NED and/or with respect to deviations of the technical image data Dₑₛ, D_{eb}, G, B1, B2, 28, 29, FD, NFD based on the afore mentioned analysis; and
a third further program step 108, 208 of outputting a result message to a user and/or storing result data in a memory unit 22 based on the result of the afore mentioned plausibility check.

Also such plausibility check can be further adapted by combining the respective program steps with further steps or features of using such plausibility check together with further embodiments as described in this document and/or in any arrangement as described in this document.

Although specific embodiments of the invention are illustrated and described herein, it will be appreciated by those of ordinary skill in the art that a variety of alternate and/or equivalent implementations exist. It should be appreciated that the exemplary embodiment or exemplary embodiments are examples only and are not intended to limit the scope, applicability, or configuration in any way. Rather, the foregoing summary and detailed description will provide those skilled in the art with a convenient road map for implementing at least one exemplary embodiment, it being understood that various changes may be made in the function and arrangement of elements described in an exemplary embodiment without departing from the scope as set forth in the appended claims and their legal equivalents. Generally, this application is intended to cover any adaptations or variations of the specific embodiments discussed herein.

It will also be appreciated that in this document the terms “comprise”, “comprising”, “include”, “including”, “contain”, “containing”, “have”, “having”, and any variations thereof, are intended to be understood in an inclusive (i.e. non-exclusive) sense, such that the process, method, device, apparatus or system described herein is not limited to those features or parts or elements or steps recited but may include other elements, features, parts or steps not expressly listed or inherent to such process, method, article, or apparatus. Furthermore, the terms “a” and “an” used herein are intended to be understood as meaning one or more unless explicitly stated otherwise. Moreover, the terms “first” , “second”, “third”, etc. are used merely as labels, and are not intended to impose numerical requirements on or to establish a certain ranking of importance of their objects.

### LIST OF REFERENCE SIGNS

1 exterior rear view assembly
2 image capturing device
3 image sensor
4 lens
5 focal length
6 minimum focusing distance
7 field of view
8 non-focusing/blur area
9 focusing/sharpness area
10 minimum focusing distance plane
11 first object/contour
12 second object/contour
13 third object/contour
14 fourth object/contour
15 image data
16 threshold value line
17 range
18 first image area
19 second image area
20 reference body
21 data processing unit
22 memory unit
23 communication unit
24 exterior rear view assembly orientation unit
25 wireless receiver unit
26 interface unit
27 sensor
28 sharp edge intensity distribution
29 blurred edge intensity distribution
30 user interface unit
101 first program step
102 intermediate program step
103 first intermediate program step
104 second intermediate program step
105 final program step
106 first further program step
107 second further program step
108 third further program step
201 first program step
202 second program step
203 third program step
204 fourth program step
205 fifth program step
206 first further program step
207 second further program step
208 third further program step
B1 first image brightness
B2 second image brightness
G gradient
I intensity
D distance
Dₑₛ sharp edge intensity rise distance
D_{eb} blurred edge intensity rise distance
BT image brightness threshold value
DT intensity rise distance threshold value
GT gradient threshold value

1. Method of determining the orientation of an exterior rear view assembly with respect to a reference body, in particular a vehicle body, wherein:
image data of an image sensor mounted to the exterior rear view assembly or to the reference body is analyzed with respect to technical image data (Dₑₛ, D_{eb}, G, B1, B2, 28, 29, FD, NFD) comprising technical image parameter data (Dₑₛ, D_{eb}, G, B1, B2, 28, 29) and/or focusing data (FD) and/or non-focusing data (NFD); and
an indication for the orientation of the exterior rear view assembly with respect to the reference body and/or an indication for a deviation of the orientation of the exterior rear view assembly with respect to the reference body is derived from the technical image data (Dₑₛ, D_{eb}, G, B1, B2, 28, 29, FD, NFD) and/or from deviations of the technical image data (Dₑₛ, D_{eb}, G, B1, B2, 28, 29, FD, NFD).

2. Method according to claim 1, wherein
an edge detection algorithm is executed with respect to the image data;
focusing data (FD) and/or non-focusing data (NFD) is derived from the edge detection algorithm, in particular correlated with data of least one image area of the image data and
an indication for the orientation of the exterior rear view assembly with respect to the reference body and/or an indication for a deviation of the orientation of the exterior rear view assembly with respect to the reference body is derived from the focusing data (FD) and/or non-focusing (NFD) data, in particular correlated with the data of the at least one image area.

3. Method according to claim 1, wherein
the technical image parameter data (Dₑₛ, D_{eb}, G, B1, B2, 28, 29) contain image blur parameter data (D_{eb}, G, 29) and/or image sharpness parameter data (Dₑₛ, G, 28), and/or image brightness parameter data (B1, B2), and/or image contrast parameter data, and/or image saturation parameter data.

4. Method according to claim 1, wherein
an indication for the folding of the exterior rear view assembly towards the reference body, in particular towards a vehicle body, is derived from technical image data (Dₑₛ, D_{eb}, G, B1, B2, 28, 29, FD, NFD) correlated with data of an image area where the technical image data (Dₑₛ, D_{eb}, G, B1, B2, 28, 29, FD, NFD) characteristic for this image area indicate non-focusing (NFD), and/or image blur (D_{eb}, G, 29) and/or low image brightness (B1) of the image data.

5. Method of determining the orientation of an exterior rear view assembly with respect to a reference body, in particular a vehicle body, in particular according to claim 1, comprising the steps of:
reading first image data from an image sensor mounted to the exterior rear view assembly or to the reference body;
analyzing the first image data respect to first technical image data (Dₑₛ, D_{eb}, G, B1, B2, 28, 29, FD, NFD);
comparing the first image data with stored second image data with respect to technical image data (Dₑₛ, D_{eb}, G, B1, B2, 28, 29, FD, NFD) and/or comparing the first technical image data (Dₑₛ, D_{eb}, G, B1, B2, 28, 29, FD, NFD) with stored second technical image data (Dₑₛ, D_{eb}, G, B1, B2, 28, 29, FD, NFD) and/or comparing the first technical image data (Dₑₛ, D_{eb}, G, B1, B2, 28, 29, FD, NFD) with stored threshold values (BT, DT, GT) of technical image data (Dₑₛ, D_{eb}, G, B1, B2, 28, 29, FD, NFD); and
deriving therefrom the orientation of the exterior rear view assembly with respect to the reference body and/or a deviation of the orientation of the exterior rear view assembly with respect to the reference body.

6. Method according to claim 1, further comprising:
analyzing the image area where at least one technical image data (Dₑₛ, D_{eb}, G, B1, B2, 28, 29, FD, NFD) exceeds or falls below a threshold value (BT, DT, GT) of the least one technical image data (Dₑₛ, D_{eb}, G, B1, B2, 28, 29, FD, NFD); and
deriving an indication for the orientation of the exterior rear view assembly and/or for a deviation of the orientation of the exterior rear view assembly from the image area and/or from deviations of the image area where at least one technical image data (Dₑₛ, D_{eb}, G, B1, B2, 28, 29, FD, NFD) exceeds or falls below such threshold value (BT, DT, GT).

7. Method according to claim 1, further comprising:
analyzing data from at least one data source and/or from at least one sensor in particular time data and/or position data and/or acceleration data and/or orientation data and/or environmental data with respect to the reference body; and
performing a plausibility check with respect to the technical image data (Dₑₛ, D_{eb}, G, B1, B2, 28, 29, FD, NFD) and/or with respect to deviations of the technical image data (Dₑₛ, D_{eb}, G, B1, B2, 28, 29, FD, NFD) and/or with respect to the indication for the orientation and/or with respect to the indication for a deviation of the orientation of the exterior rear view assembly with respect to the reference body based on the afore mentioned analysis.

8. Arrangement for determining the orientation of an exterior rear view assembly with respect to a reference body, in particular a vehicle body, containing:
an image sensor mounted to the exterior rear view assembly or to the reference body;
a data processing unit configured for:
reading image data and/or technical image data (Dₑₛ, D_{eb}, G, B1, B2, 28, 29, FD, NFD) from the image sensor;
analyzing technical image data (Dₑₛ, D_{eb}, G, B1, B2, 28, 29, FD, NFD) of said image data;
deriving orientation data which indicates the orientation of the exterior rear view assembly with respect to the reference body from the technical image data (Dₑₛ, D_{eb}, G, B1, B2, 28, 29, FD, NFD) and/or deriving deviation data which indicate a deviation of the orientation of the exterior rear view assembly with respect to the reference body from deviations of the technical image data (Dₑₛ, D_{eb}, G, B1, B2, 28, 29, FD, NFD).

9. Arrangement for determining the orientation of an exterior rear view assembly according to claim 8, wherein the data processing unit is configured for
executing an edge detection algorithm with
respect to the image data
deriving focusing data (FD) and/or non-focusing data (NFD) from the edge detection algorithm, in particular correlated with data of least one image area of the image data and
deriving an indication for the orientation of the exterior rear view assembly with respect to the reference body from the focusing data (FD) and/or non-focusing (NFD) data, in particular correlated with the data of the at least one image area; and/or
deriving an indication for a deviation of the orientation of the exterior rear view assembly with respect to the reference body from the focusing data (FD) and/or non-focusing (NFD) data, in particular correlated with the data of the at least one image area.

10. Arrangement for determining the orientation of an exterior rear view assembly according to claim 8, wherein the technical image parameter data (Dₑₛ, D_{eb}, G, B1, B2, 28, 29) contain image blur parameter data (D_{eb}, G, 29) and/or image sharpness parameter data (D_{eb}, G, 28), and/or image brightness parameter data (B1, B2), and/or image contrast parameter data, and/or image saturation parameter data.

11. Arrangement according to claim 8, wherein the data processing unit is configured for
deriving an indication for the folding of the exterior rear view assembly towards the reference body, in particular towards a vehicle body, from technical image data (Dₑₛ, D_{eb}, G, B1, B2, 28, 29, FD, NFD) correlated with data of an image area where the technical image data (Dₑₛ, D_{eb}, G, B1, B2, 28, 29, FD, NFD) characteristic for this image area indicate non-focusing (NFD), and/or image blur (D_{eb}, G, 29) and/or low image brightness (B1) of the image data.

12. Arrangement for determining the orientation of an exterior rear view assembly with respect to a reference body, in particular a vehicle body, in particular according to claim 8, containing:
a memory unit configured for storing image data and/or technical image data (Dₑₛ, D_{eb}, G, B1, B2, 28, 29, FD, NFD); and
a data processing unit, configured for:
reading image data and/or technical image data (Dₑₛ, D_{eb}, G, B1, B2, 28, 29, FD, NFD) and/or threshold value data (BT, DT, GT) of technical image data (Dₑₛ, D_{eb}, G, B1, B2, 28, 29, FD, NFD) from the image sensor and the memory unit;
analyzing and comparing technical image data (Dₑₛ, D_{eb}, G, B1, B2, 28, 29, FD, NFD) and/or threshold value data (BT, DT, GT) of technical image data (Dₑₛ, D_{eb}, G, B1, B2, 28, 29, FD, NFD);
deriving from the comparison orientation data which indicates the orientation of the exterior rear view assembly with respect to the reference body and/or deviation data which indicates a deviation of the orientation of the exterior rear view assembly with respect to the reference body.

13. Arrangement for determining the orientation of an exterior rear view assembly according to claim 8, wherein the data processing unit is configured for
analyzing the image area where at least one technical image data (Dₑₛ, D_{eb}, G, B1, B2, 28, 29, FD, NFD) exceeds or falls below a threshold value (BT, DT, GT) of the least one technical image data (Dₑₛ, D_{eb}, G, B1, B2, 28, 29, FD, NFD); and
deriving an indication for the orientation of the exterior rear view assembly and/or for a deviation of the orientation of the exterior rear view assembly from the image area and/or from deviations of the image area where at least one technical image data (Dₑₛ, D_{eb}, G, B1, B2, 28, 29, FD, NFD) exceeds or falls below such threshold value (BT, DT, GT).

14. Arrangement for determining the orientation of an exterior rear view assembly according to claim 8, wherein
the data processing unit is connected to at least one data source and/or to at least one sensor for providing time data and/or position data and/or acceleration data and/or orientation data and/or environmental data with respect to the reference body; and
the data processing unit is configured for:
analyzing time data and/or position data and/or acceleration data and/or orientation data and/or environmental data with respect to the reference body; and for performing a plausibility check with respect to the technical image data (Dₑₛ, D_{eb}, G, B1, B2, 28, 29, FD, NFD) and/or with respect to deviations of the technical image data (Dₑₛ, D_{eb}, G, B1, B2, 28, 29, FD, NFD) and/or with respect to the indication for the orientation and/or with respect to the indication for a deviation of the orientation of the exterior rear view assembly with respect to the reference body based on the afore mentioned analysis.

15. Data processing program product for determining the orientation of an exterior rear view assembly with respect to a reference body, in particular a vehicle body, comprising instructions which, when the program is executed by a data processing unit cause the data processing unit to carry out the following program steps, in particular according to a method according to claim 1:
a first program step of reading first image data from an image sensor mounted to the exterior rear view assembly or to the reference body;
an intermediate program step of analyzing the first image data with respect to technical image data (Dₑₛ, D_{eb}, G, B1, B2, 28, 29, FD, NFD) comprising technical image parameter data (Dₑₛ, D_{eb}, G, B1, B2, 28, 29) and/or focusing data (FD) and/or non-focusing data (NFD); and
a final program step of deriving orientation data which indicate the orientation of the exterior rear view assembly with respect to the reference body and/or of deriving deviation data which indicate a deviation of the orientation of the exterior rear view assembly with respect to the reference body from the technical image data (Dₑₛ, D_{eb}, G, B1, B2, 28, 29 FD, NFD) and/or from deviations of the technical image data (Dₑₛ, D_{eb}, G, B1, B2, 28, 29, FD, NFD).

16. Data processing program product according to claim 15, wherein
the intermediate program step comprises:
a first intermediate program step of executing an edge detection algorithm with respect to the image data
a second intermediate program step of deriving focusing data (FD) and/or non-focusing data (NFD) from the edge detection algorithm, in particular correlated with data of least one image area of the image data
and wherein
the final program step consists of deriving orientation data which indicate the orientation of the exterior rear view assembly with respect to the reference body and/or of deriving deviation data which indicate a deviation of the orientation of the exterior rear view assembly with respect to the reference body from the focusing data (FD) and/or non-focusing (NFD) data, in particular correlated with the data of the at least one image area.

17. Data processing program product according to claim 15, wherein
the technical image parameter data (Dₑₛ, D_{eb}, G, B1, B2, 28, 29) contain image blur parameter data (D_{eb}, G, 29) and/or image sharpness parameter data (Dₑₛ, G, 28), and/or image brightness parameter data (B1, B2), and/or image contrast parameter data, and/or image saturation parameter data; and/or
wherein the final program step consists of deriving folding indication data which indicate the folding of the exterior rear view assembly towards the reference body, from technical image data (Dₑₛ, D_{eb}, G, B1, B2, 28, 29, FD, NFD) correlated with data of an image area where the technical image data (Dₑₛ, D_{eb}, G, B1, B2, 28, 29, FD, NFD) characteristic for this image area indicate non-focusing (NFD), and/or image blur (D_{eb}, G, 29) and/or low image brightness (B1) of the image data

18. Data processing program product for determining the orientation of an exterior rear view assembly with respect to a reference body, in particular a vehicle body, comprising instructions which, when the program is executed by a data processing unit cause the data processing unit to carry out the following program steps, in particular according to a method according to claim 1:
a first program step of reading first image data from an image sensor mounted to the exterior rear view assembly or to the reference body;
a second program step of analyzing the first image data with respect to first technical image data (Dₑₛ, D_{eb}, G, B1, B2, 28, 29, FD, NFD);
a third program step of reading stored second image data and/or stored second technical image data (Dₑₛ, D_{eb}, G, B1, B2, 28, 29, FD, NFD) and/or stored threshold value data (BT, DT, GT) of technical image data (Dₑₛ, D_{eb}, G, B1, B2, 28, 29, FD, NFD) from a memory unit;
a fourth program step of comparing the first image data with stored second image data with respect to technical image data (Dₑₛ, D_{eb}, G, B1, B2, 28, 29, FD, NFD) and/or comparing the first technical image data (Dₑₛ, D_{eb}, G, B1, B2, 28, 29, FD, NFD) with stored second technical image data (Dₑₛ, D_{eb}, G, B1, B2, 28, 29, FD, NFD) and/or comparing the first technical image data (Dₑₛ, D_{eb}, G, B1, B2, 28, 29, FD, NFD) with stored threshold values (BT, DT, GT) of technical image data (Dₑₛ, D_{eb}, G, B1, B2, 28, 29, FD, NFD); and
a fifth program step of deriving from the comparison orientation data which indicates the orientation of the exterior rear view assembly with respect to the reference body and/or deviation data which indicates a deviation of the orientation of the exterior rear view assembly with respect to the reference body.

19. Data processing program product according to claim 15, comprising instructions which, when the program is executed by a data processing unit, cause the data processing unit to carry out the following further program steps:
a first further program step of analyzing data from at least one data source and/or from at least one sensor, in particular time data and/or position data and/or acceleration data and/or orientation data and/or environmental data with respect to the reference body;
a second further program step of performing a plausibility check with respect to the technical image data (Dₑₛ, D_{eb}, G, B1, B2, 28, 29, FD, NFD) and/or with respect to deviations of the technical image data (Dₑₛ, D_{eb}, G, B1, B2, 28, 29, FD, NFD) and/or with respect to the orientation data and/or with respect to the deviation data based on the afore mentioned analysis; and
a third further program step of outputting a result message to a user and/or storing result data in a memory unit based on the result of the afore mentioned plausibility check.
